(19) United States
(12) Patent Application Publication
(10) Pub. No.: US 2016/0027220 A1
(43) Pub. Date: Jan. 28, 2016

(54) LOW LATENCY METHODOLOGIES FOR A HEADSET-MOUNTED CAMERA ON VIRTUAL REALITY DISPLAYS

(71) Applicant: JRC Integrated Systems, Inc., Washington, DC (US)

(72) Inventor: Antonio Jimenez, Springfield, VA (US)

(21) Appl. No.: 14/807,784

(22) Filed: Jul. 23, 2015

Related U.S. Application Data
(60) Provisional application No. 62/028,422, filed on Jul. 24, 2014.

(51) Int. Cl. G06T 19/00; G02B 27/01; G06F 3/01; G09G 5/18

(52) U.S. Cl. CPC G06T 19/006; G09G 5/18; G02B 27/0172; G06F 3/017

(57) ABSTRACT

Systems and methods for camera and inertial sensor integration are described. The systems and methods may include receiving inertial data from one or more inertial sensors; processing the inertial data with an inertial sensor algorithm to produce an inertial sensor position and orientation; receiving camera data from one or more cameras; processing the camera data and the inertial sensor position with a camera sensor algorithm to produce a camera position and orientation; receiving the inertial sensor position and the camera position in a Kalman filter to determine position or orientation of a user wearing a virtual reality headset; and providing the user's position or orientation to the virtual reality headset. An apparatus that incorporates these systems and methods is also set forth.

### INCORPORATION BY REFERENCE TO RELATED PATENT APPLICATIONS

This application claims benefit under 35 U.S.C. §119(e) from U.S. Provisional Application No. 62/028,422, filed on Jul. 24, 2014. The disclosure of the application cited in this paragraph is incorporated herein by reference in its entirety.

### FIELD OF THE INVENTION

The present invention relates to systems and methods for virtual reality displays, and, more specifically, to systems and methods for camera and inertial sensor integration for improving virtual reality displays to minimize the effect of latency.

### BACKGROUND OF THE INVENTION

Virtual reality headsets are known, but often suffer from various drawbacks from technical and user standpoints.

In certain existing systems, virtual reality (VR) headsets use an inertial sensor mounted on the display to track the orientation of the headset. While providing a somewhat low latency response, a major problem with using just an inertial sensor is drift due to inaccuracy of the inertial sensor. This can cause the user to experience nausea and is a major limiting factor for users to be able to use the virtual reality for any extended period of time, and for some users who are particularly sensitive to drift-induced nausea, even short-term use can cause discomfort.

Certain existing systems may use an off-headset mounted camera with trackable infrared (IR) light emitting diodes (LEDs) on the headset. An off-headset mounted camera is needed, instead of an on-headset mounted camera, because the latency involved in trying to calculate the position/orientation (pos/ori) with an on-headset camera is too high. An off-headset camera can more quickly track and calculate the pos/ori of the user, but that has significant drawbacks as well, as the user is then limited to the field of view of that camera. Also, if the user turns around or otherwise occludes the line of sight with the off-headset camera, the IR LEDs will not be in view of the camera and the pos/ori calculation will begin to drift, potentially causing nausea.

Other existing systems have proposed and demonstrated an on-headset camera that requires the use of Quick Response (QR)-type codes mounted on the walls of the user space. The QR-type codes are needed to eliminate the need to track objects and quickly extract point features. The system only works, however, on surfaces plastered with these QR-type codes and require significant setup time and effort.

Improved systems and methods for camera and inertial sensor integration for use in virtual reality displays are needed.

### SUMMARY OF THE INVENTION

Embodiments of the present invention solve many of the problems and/or overcome many of the drawbacks and disadvantages of the prior art by providing systems and methods for camera and inertial sensor integration.

Embodiments of the present invention may include systems and methods for camera and inertial sensor integration. The systems and methods may include receiving inertial data from one or more inertial sensors; processing the inertial data with an inertial sensor algorithm to produce an inertial sensor position and/or orientation; receiving camera data from one or more cameras; processing the camera data and the inertial sensor position with a camera sensor algorithm to produce a camera position and/or orientation; receiving the inertial sensor position and the camera position in a Kalman filter to determine position or orientation of a user wearing a virtual reality headset; and providing the user's position or orientation to the virtual reality headset. The systems and methods described herein can also be incorporated by conventional means into an apparatus with various components for ease of distribution, sale and use of a product that provides delivers the benefits of the inventions described herein to the end user.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a system and method of camera and inertial sensor integration.

FIG. 2 shows an exemplary system for camera and inertial sensor integration according to one embodiment.

FIG. 3 shows an exemplary system for computational aspects of camera and inertial sensor integration according to one embodiment.

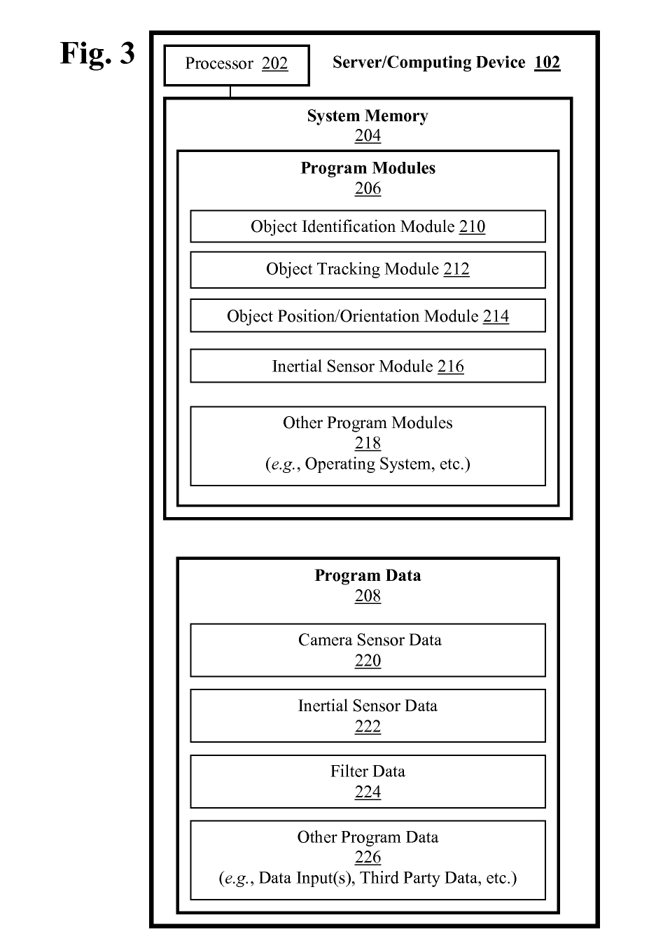

FIG. 4 shows an exemplary method of camera and inertial sensor integration according to one embodiment.

FIG. 5 shows an exemplary camera sensor algorithm according to one embodiment.

### DETAILED DESCRIPTION OF THE PREFERRED EMBODIMENTS

Systems and methods are described for using various tools and procedures for camera and inertial sensor integration. In certain embodiments, the tools and procedures may be used in conjunction with virtual reality systems. The examples described herein relate to virtual reality systems for illustrative purposes only. The systems and methods described herein may be used for many different industries and purposes, including, in addition to virtual reality, simulations, graphics, and/or completely different industries. In particular, the systems and methods may be used for any industry or purpose where camera and sensor integration is needed. For multi-step processes or methods, steps may be performed by one or more different parties, servers, processors, etc.

Certain embodiments describe systems and methods to implement a headset mounted camera on a virtual reality display to provide better positional/orientation tracking than using inertial sensors alone. Current methods have limitations that require the camera to be placed on a stand in front of the user to achieve the required latency or use predetermined patterns mounted to walls that do not work on surfaces without these patterns. Certain embodiments described herein may have a robust implementation that may not require these patterns and provides the required latency and accuracy from the headset mounted camera for the virtual reality display. Certain embodiments may integrate data from an inertial sensor into a camera sensor algorithm to more quickly calculate the object tracking and positional/orientation calculation from the camera. Certain embodiments may also use laser scanning modeling and/or 360 degree mirror lenses.

Although not required, the systems and methods are described in the general context of computer program instructions executed by one or more computing devices that can take the form of a traditional server/desktop/laptop; mobile device such as a smartphone or tablet; etc. Computing devices typically include one or more processors coupled to data storage for computer program modules and data. Key technologies include, but are not limited to, the multi-industry standards of Microsoft and Linux/Unix based Operating Systems; databases such as SQL Server, Oracle, NOSQL, and DB2; Business Analytic/Intelligence tools such as SPSS, Cognos, SAS, etc.; development tools such as Java,.NET Framework (VB.NET, ASP.NET, AJAX.NET, etc.); and other e-Commerce products, computer languages, and development tools. Such program modules generally include computer program instructions such as routines, programs, objects, components, etc., for execution by the one or more processors to perform particular tasks, utilize data, data structures, and/or implement particular abstract data types. While the systems, methods, and apparatus are described in the foregoing context, acts and operations described hereinafter may also be implemented in hardware.

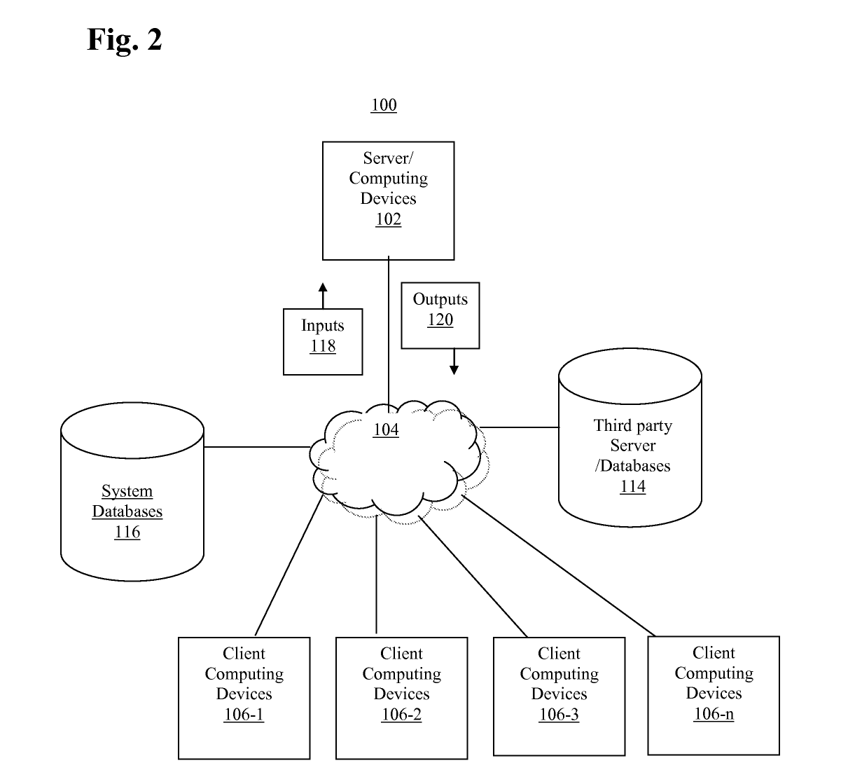

FIG. 2 shows an exemplary system 100 for camera and inertial sensor integration according to one embodiment. In this exemplary implementation, system 100 may include one or more servers/computing devices 102 (e.g., server 1, server 2, . . . , server n) operatively coupled over network 104 to one or more client computing devices 106-1 to 106-n, which may include one or more consumer computing devices, one or more provider computing devices, one or more remote access devices, etc. The one or more servers/computing devices 102 may also be operatively connected, such as over a network, to one or more third party servers/databases 114 (e.g., database 1, database 2, . . . , database n). The one or more servers/computing devices 102 may also be operatively connected, such as over a network, to one or more system databases 116 (e.g., database 1, database 2, . . . , database n). Various devices may be connected to the system, including, but not limited to, client computing devices, consumer computing devices, provider computing devices, remote access devices, etc. This system may receive inputs 118 and outputs 120 from the various computing devices, servers and databases.

Server/computing device 102 may represent, for example, any one or more of a server, a general-purpose computing device such as a server, a personal computer (PC), a laptop, a smart phone, a tablet, and/or so on. Networks 104 represent, for example, any combination of the Internet, local area network(s) such as an intranet, wide area network(s), cellular networks, WIFI networks, and/or so on. Such networking environments are commonplace in offices, enterprise-wide computer networks, etc. Client computing devices 106, which may include at least one processor, represent a set of arbitrary computing devices executing application(s) that respectively send data inputs to server/computing device 102 and/or receive data outputs from server/computing device 102. Such computing devices include, for example, one or more of desktop computers, laptops, mobile computing devices (e.g., tablets, smart phones, human wearable device), server computers, and/or so on. In this implementation, the input data comprises, for example, camera data, sensor data, and/or so on, for processing with server/computing device 102. In one implementation, the data outputs include, for example, images, camera readings, sensor readings, coordinates, emails, templates, forms, and/or so on. Embodiments of the present invention may also be used for games or collaborative projects with multiple users logging in and performing various operations on a data project from various locations. Embodiments of the present invention may be web-based, smart phone-based and/or tablet-based or human wearable device based.

In this exemplary implementation, server/computing device 102 includes at least one processor coupled to a system memory. System memory may include computer program modules and program data.

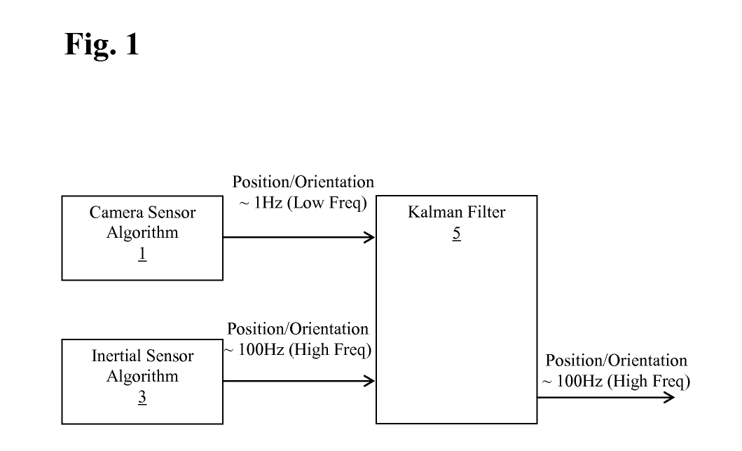

In this exemplary implementation, server/computing device 102 includes at least one processor 202 coupled to a system memory 204, as shown in FIG. 2. System memory 204 may include computer program modules 206 and program data 208. In this implementation program modules 206 may include object identification module 210, object tracking module 212, object position/orientation module 214, inertial sensor module 216, and other program modules 218 such as an operating system, device drivers, etc. Each program module 210 through 216 may include a respective set of computer-program instructions executable by processor(s) 202. This is one example of a set of program modules and other numbers and arrangements of program modules are contemplated as a function of the particular arbitrary design and/or architecture of server/computing device 102 and/or system 100 (FIG. 1). Additionally, although shown on a single server/computing device 102, the operations associated with respective computer-program instructions in the program modules 206 could be distributed across multiple computing devices. Program data 208 may include camera sensor data 220, inertial sensor data 222, filter data 224, and other program data 226 such as data input(s), third party data, and/or others.

Certain embodiments may solve latency and tracking problems by better integrating the inertial sensor data into the camera sensor algorithm, allowing the use of an on-headset camera without the need for wall mounted QR-type codes. This may reduce or eliminate the nausea problem for users of virtual reality and may allow complete freedom of movement to the user. It also may not require the use of QR-type codes to be mounted in the user space.

Standard image recognition software may break down an object using feature detection into image features such as edges, ridges, interest points, blobs, etc. For example, in facial recognition algorithms, a face can be broken down using feature detection into the interest points that are then used to identify the face. With star trackers, star constellations are the interest points that are identified and tracked.

### Rapid Position and Orientation Calculation for Image Sensors using an Inertial Sensor

For any on-headset camera sensor, image tracking and recognition software may be used. In certain systems standard image recognition software for photographs may be used to process rotational objects. The systems may perform feature detection to calculate the image features and then provide methods to search in a database for those image features and possible rotations of those image features. In certain embodiments, as used with on-headset camera sensors, instead of trying to actually identify the object in the database, the systems and methods may determine the angular rotation (quaternion) and position displacement of the image features that are used to create the searchable QR-type code for image recognition. The object's point features pos/ori along with all of the other tracked objects may then be used to determine the user's pos/ori. In certain embodiments, only a position of an object may be tracked without the corresponding tracking of orientation. For example, spheres and points may not require tracking of orientation, but instead only tracking of position may be used.

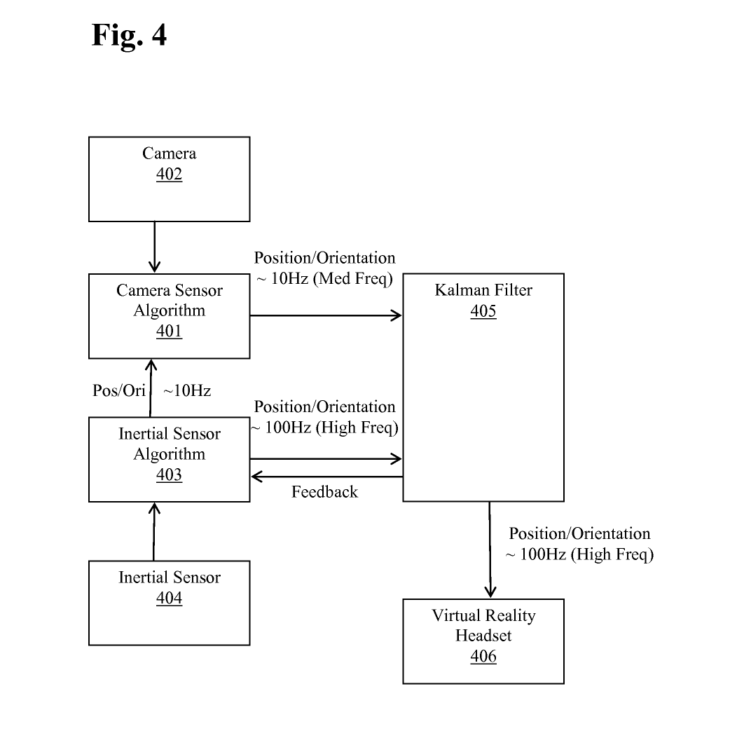

Certain embodiments may utilize an inertial sensor to greatly speed up target and object tracking Passing data from one or more inertial sensors into the image processing algorithm may allow it to predict rotation and position displacement of the expected image features. As shown in FIG. 1, certain systems may provide data from an inertial sensor algorithm 3 and data from a camera sensor algorithm 1 together into a Kalman filter 5 to determine position and orientation. Utilizing the inertial sensor as shown in FIG. 4, can greatly speed up target and object tracking compared to systems such as those in FIG. 1.

A Kalman filter 5, also known as linear quadratic estimation (LQE), may be an algorithm that uses a series of measurements observed over time, containing noise (random variations) and other inaccuracies, and may produce estimates of unknown variables that tend to be more precise than those based on a single measurement alone. The Kalman filter may operate recursively on streams of noisy input data to produce a statistically optimal estimate of the underlying system state. The algorithm may operate in a two-step process. In a prediction step, the Kalman filter may produce estimates of the current state variables, along with their uncertainties. Once the outcome of the next measurement (necessarily corrupted with some amount of error, including random noise) is observed, these estimates may be updated using a weighted average, with more weight being given to estimates with higher certainty. Because of the algorithm's recursive nature, it can run in real time using only the present input measurements and the previously calculated state and its uncertainty matrix; no additional past information may be required.

As shown in FIG. 4, certain embodiments may use an inertial sensor algorithm 403 that provides input to a camera sensor algorithm 401. An inertial sensor 404 may provide readings and/or measurements of position/orientation to the inertial sensor algorithm 403. The inertial sensor may measure a plurality of variables. In certain embodiments, the inertial sensor may measure at least 6 degrees of freedom (x,y,z, and θₓ, θ_{y} and θ_{z}). This may be performed using three accelerometers and three gyroscopes. Magnetometer readings may be optional. These readings and/or measurements may be received at predetermined frequencies. In certain embodiments, the readings and/or measurements may be received at a higher frequency than readings from a camera received at a camera sensor algorithm. In certain embodiments, the reading and/or measurements may be received at approximately 100 Hz depending on the quality of the sensors. The readings and/or measurements from the inertial sensor 404 may be processed by the inertial sensor algorithm 403. These acceleration readings and/or measurements may be integrated overtime by the inertial sensor algorithm 403 to calculate the velocity and then integrated again to calculate the position and orientation. The inertial sensor algorithm may output the position measurements, such as the six degree of freedom positions measurements (x,y,z, and θₓ, θ_{y} and θ_{z}). The output from the inertial sensor algorithm 403 may be sent to the camera sensor algorithm 401.

The camera sensor algorithm 401 may also receive input from a camera 402. The camera algorithm may provide various types of data, but primarily may provide image data. Image data may be from various types of cameras, such as traditional lenses, 360 degree lenses, etc. Data from the camera may be received at a predetermined rate. In certain embodiments, data from the camera may be received at a lower rate than data received from the inertial sensors in the inertial sensor algorithm. In certain embodiments, data may be received at approximately 10 Hz.

The camera sensor algorithm 401 may use input from the inertial sensor algorithm 403 and the camera 402. Certain embodiments may provide for faster and/or more efficient tracking in virtual reality systems. Images received from a camera may require feature extraction and/or image detection. A whole image may be received from a camera, and it may be time consuming to analyze the whole image. The camera sensor algorithm 401 may narrow the search field of view to improve processing speed. In certain embodiments, the camera sensor algorithm 401 may determine, based on the inertial sensor data, that an object, particularly if a specific size, should be found in a certain location. Therefore, the system may search only in a narrowed image area based on the processing. In certain embodiments, the size of the expected field of view may be expanded by the amount of expected error from the inertial sensor data reading and/or measurement. For example, if the expected error is a drift of 100 arc-sec, then the field of view may be increased by that amount to determine the search area. Error may be based on characteristics of the inertial sensor hardware. The camera sensor algorithm 401 may output a calculation of position and orientation for one or more objects. In certain embodiments, multiple objects may be tracked. In certain embodiments, there may be upper limits on the number of objects tracked. For multiple tracked objects, the camera sensor algorithms determined position/orientation may be a combination of position/orientation determinations from multiple objects. In certain embodiments, the position/orientation may be an average of data for various objects. In certain embodiments, the position/orientation may select data for certain objects to be used in calculations, such as discarding outlying data. In certain embodiments, the position/orientation may weight data from different objects, differentially weigh detection scores, and/or remove outliers. The inertial sensor input may be used to predict where an object would be within in the camera sensor algorithm. Therefore, the systems and methods may only do point feature extraction on the region or area where the object is expected to be and only on objects that are expected to be viewable. This may significantly reduce the time required for feature extraction.

A Kalman filter 405 may receive input from the inertial sensor algorithm 403 and the camera sensor algorithm 401. The Kalman filter 405 may process the inputs to create an output to a virtual reality headset 406. In certain embodiments, outputs may be a six degree of freedom position/orientation output (x,y,z, and θₓ, θ_{y} and θ_{z}).

The systems and methods may also predict the rotational and positional displacement of the point features of the object. Certain embodiments may not just speed up image tracking and calculation, but may also speed up feature extraction. Image features may be identified after reducing the search area. In certain embodiments, the systems and methods may change appearance after a rotation. For example, a square viewed headon would appear as a square, but when viewed at an angle may appear as a trapezoidal shape. The anticipated appearance may be determined to further expedite searches for features. Inertial data may be used to calculate what features may look like and use that modified shape to speed up searches. The expected rotated and displaced point features for an object may be compared to the measured point features from the feature extraction. The difference between the pos/ori of the point features of all valid tracked objects may then be averaged into a corrective pos/ori. This corrected pos/ori may then be passed into the Kalman filter 405.

The maximum frequency of the Kalman filter 405 may be set by the highest frequency input into the Kalman Filter. As noted previously, inertial sensors may have drift. The Kalman filter 405 may compares pos/ori from the camera sensor algorithm and the inertial sensor algorithm. In certain embodiments, the Kalman filter may receive a higher frequency of data updates from inertial sensor algorithm as compared to updates from the camera sensor algorithm. For example, the camera sensor algorithm may only update at approximately 10 Hz, while the inertial sensor algorithm may update at approximately 100 Hz. The Kalman filter may provide feedback updates of the inertial sensor position to the inertial sensor algorithm based on the camera sensor algorithm pos/ori. The feedback may be sent at approximately the same frequency as data is received from the camera sensor algorithm.

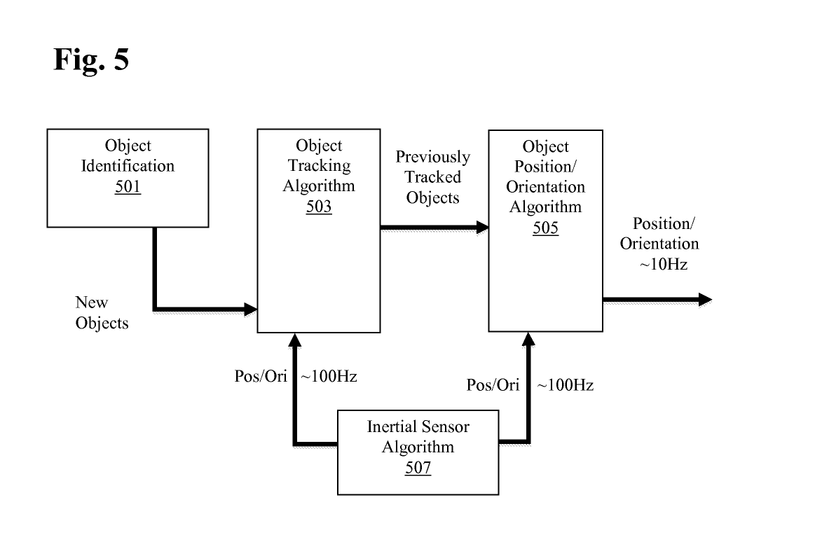

FIG. 5 illustrates an exemplary camera sensor algorithm 401. Object tracking may take multiple objects and filter out those that have been determined to have moved. Object filtering may be performed by comparing the expected position and orientation from the inertial data. If the difference is higher than some percentage of the expected error of the inertial sensor, then the object is assumed to have moved and is removed from of the algorithm. New objects may be identified from an object identification system 501. An object tracking algorithm 503 may receive information regarding the new objects and/or from an inertial sensor algorithm 507. Information regarding previously tracked objects may be sent to an object position/orientation algorithm 505, which may also receive information from the inertial sensor algorithm 507. Information from the object position/orientation algorithm 505 may be sent out.

Only previously tracked objects may be used to generate the relative change in the previous position of the user. The newly tracked objects may be sent to the object tracking algorithm for use in the next iteration.

In certain embodiments, the required number of objects may be achieved so that quickly turning users maintain a track on at least one object to determine motion from the image sensor. A Wide Field of View (WFOV) lens or a 360 degree mirror lens may be mounted on top of the headset to maintain a larger set of trackable objects. If using a 360 degree mirror lens, it may be mounted so that it is completely free of occlusions from the user's head. If the headset is tall enough, the mirror lens can be placed on top of that. If not, then the mirror lens may be on a hard or flexible component that extends over to the top of the user's head.

To go from object positions to user orientation, the distance to the object must be determined. Various methods can be used to solve this.

A 360 degree initialization may be required to calculate all trackable objects in the user space. The user may be required to walk in a small diameter circle for the initialization to capture a full view of the user space. This may calculate all trackable objects in the space and based on their position and displacement may build an accurate object model of the room. The distance between the objects can be used to triangulate the distance from the user to each object. Only non-moving objects should be in the room during initialization.

Alternatively, certain embodiments may use a low resolution laser scanner to track object distances. This can be integrated in either a WFOV lens or a 360 degree mirror lens.

The user's body parts can be visualized using a WFOV laser scanner mounted on the front of the headset. Just like the MICROSOFT KINECT is used to create and track a model of the human body, a front headset mounted laser scanner can predict the location of the user's legs and arms, and then track and display them on the headset display. In other words, the user may look down and the inertial sensor may notify the laser object tracking software, which then expects to model the legs. The system may verify and accurately outline the user's legs or other body parts.

With a front mounted WFOV camera, a button may be added to the headset. When pressed, the video feed may be toggled between the virtual world and the real world. Alternatively, the real world can be displayed as a Picture in Picture or an overlay.

Close or rapidly approaching real world objects can be displayed to the user. The proximity or speed of the object may be determined by a laser scanner.

To achieve complete freedom of movement for the user while lowering the latency from the camera sensor, more computing power can be applied to the problem at the expense of other system latency requirements. This has drawbacks because then the system can experience frame rate issues which may also cause nausea.

Certain embodiments may be utilized on a low latency/high refresh virtual reality display that has high accuracy. The virtual reality display may have only an on-headset camera to allow for complete freedom of motion for the user.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A computerized method for camera and inertial sensor integration, the computerized method comprising the steps of:
receiving inertial data from one or more inertial sensors;
processing the inertial data with an inertial sensor algorithm to produce an inertial sensor position and orientation;
receiving camera data from one or more cameras;
processing the camera data and the inertial sensor position with a camera sensor algorithm to produce a camera position and orientation;
receiving the inertial sensor position and the camera position in a Kalman filter to determine position or orientation of a user wearing a virtual reality headset; and
providing the user's position or orientation to the virtual reality headset.

2. The method of claim 1, wherein the inertial data comprises six degrees of freedom.

3. The method of claim 1, wherein the inertial sensor algorithm processes the inertial data by integrating the inertial data to determine velocity and then integrating velocity to determine the inertial sensor position and orientation.

4. The method of claim 1, wherein the camera data comprises image data.

5. The method of claim 1, wherein the camera sensor algorithm processes the camera data and the inertial sensor position by utilizing the inertial sensor position and orientation to limit the searchable area for analysis of the camera data

6. The method of claim 1, wherein the Kalman filter filters by selecting the camera sensor position and orientation or the inertial sensor position and orientation.

7. The method of claim 1, further comprising tracking user body parts.

8. The method of claim 1, further comprising providing a toggle between a virtual world display and a real world display.

9. The method of claim 1, further comprising receiving distance information regarding tracked objects from a laser scanner.

10. The method of claim 1, further comprising receiving data regarding a 360 degree initialization.

11. The method of claim 10, wherein the 360 degree initialization comprises a user walking in a small diameter circle to capture a full view of the space.

12. A system for camera and inertial sensor integration, the system comprising:
one or more headset mounted cameras;
one or more inertial sensors; and
one or more processors, wherein the one or more processors perform the steps of:
receive input from the one or more inertial sensors;
determine a user's position or orientation using an inertial sensor algorithm based on the input from the one or more inertial sensors;
receive input from the one or more headset mounted cameras;
determine a user's position based on the user's position or orientation from the inertial sensor algorithm and the input from the one or more headset mounted cameras;
apply a Kalman filter; and
send position or orientation information to a virtual reality headset.

13. The system of claim 12, wherein the one or more headset mounted cameras comprise a wide field of view lens.

14. The system of claim 12, wherein the one or more headset mounted cameras comprise a 360 degree mirror lens.

15. The system of claim 14, wherein the 360 degree mirror lens is mounted on the virtual reality headset free of occlusions from the user's head.

16. The system of claim 12, wherein the input from the one or more inertial sensors comprises position and orientation.

17. The system of claim 12, wherein the input from the one or more headset mounted cameras comprises position and orientation of one or more tracked objects.

18. The system of claim 12, wherein the inertial sensor algorithm processes the input from the one or more inertial sensors by integrating the inertial data to determine velocity and then integrating velocity to determine the inertial sensor position and orientation.

19. The system of claim 12, wherein the camera sensor algorithm processes the user's position or orientation from the inertial sensor algorithm and the input from the one or more headset mounted cameras by utilizing the inertial sensor position and orientation to limit the field of view for analysis of the camera data.

20. The system of claim 12, wherein the Kalman filter selects the camera sensor position and orientation or the inertial sensor position and orientation.

21. An apparatus that includes a headset to be worn by a person that can provide both visual and audio signals and stimulus to the person, one or more cameras attached to said headset; one or more inertial sensors attached to said headset; one or more processors that are connected either via hard wire or wirelessly to said cameras and said sensors; a Kalman or Kalman-type filter incorporated into at least one of said processors; said processors being specifically adapted to receive and process the signals from said cameras and said sensors through said Kalman or Kalman-type filter to minimize the latency inherent in the system.
